(19) United States
(12) Patent Application Publication
(10) Pub. No.: US 2014/0374372 A1
(43) Pub. Date: Dec. 25, 2014

(54) Closure System for a Leak-Proof Bottle for Baby Food

(71) Applicants: Eckhard Itzek, Gyhum (DE); Böjrn Frederik Seidler, Scheeßel (DE)

(72) Inventors: Eckhard Itzek, Gyhum (DE); Böjrn Frederik Seidler, Scheeßel (DE)

(73) Assignee: MAPA GmbH a corporation

(21) Appl. No.: 14/233,855

(22) PCT Filed: Jul. 20, 2011
(86) PCT No.: PCT/EP2011/003636

§ 371 Date: Mar. 27, 2014

(51) Int. Cl. A61J 9/08

(52) U.S. Cl. CPC A61J 9/085
USPC 215/11.6

(57) ABSTRACT

A closure system for a bottle for baby food having a bottom shell part and a bottom closure ring that can be screwed onto a thread of a bottle, and a bottom partition wall above an inner thread on the edge connected to the bottom shell part blocking the cross-section of the bottom shell part, the bottom partition wall having a top side and a bottom side with a bottom flow hole ending in the first top side and in the bottom side, a top closure ring connectable to a threaded ring to fasten a teat to the top edge of the top shell part, with a top partition wall blocking the cross-section of the top shell part and connected at the edge to the top shelf part, locking elements locking the bottom closure ring and top closure ring in a rotatable, releasable manner, and an elastic sealing lip.

### CROSS-REFERENCE TO RELATED APPLICATIONS

This is a national stage application of PCT/EP2011/003636, Filed on Jan. 20, 2011

### STATEMENT REGARDING FEDERALLY SPONSORED RESEARCH

Not applicable.

### BACKGROUND OF THE INVENTION

The invention relates to a closure system for a leak-proof bottle for baby food.

With known bottles for baby food, the bottom edge of the nipple has a peripheral nipple flange that is sealingly fixed to the edge of a bottle opening by means of a threaded ring screwed onto the outer thread of the bottle. To prevent liquid from leaking during pauses in drinking, a cover is placed between the nipple flange and the edge of the bottle and is clamped tight by means of the threaded ring.

DE 101 57 071 C1 discloses a user-friendly, leak-proof bottle for baby food. This has a bottom closure ring screwed onto the outer thread of the bottle and possesses a first seat surface having at least one first flow hole. A top closure ring has a second seat surface with at least one second flow hole. The two sealing rings are rotatable relative to each other by means of locking elements and are releasably locked with each other. By rotating the top closure ring, the first and second flow holes can be brought into overlapping and non-overlapping positions. A teat is screwed on by means of a threaded ring to an outer thread of the top closure ring. When the flow holes overlap each other, baby food can be removed through the teat. If the flow holes do not overlap, the removal of baby food through the teat is blocked.

In the exemplary embodiment, the closure rings have conical seat surfaces. Furthermore, sealing rings are arranged on the bottom side of the bottom closure ring and on the top side of the first seat surface. The bottom closure ring has a locking projection that projects inward from the bottom conical seat surface, and the top closure ring has snap tongues projecting from the bottom second conical seat surface that engage behind the locking projection.

EP 1 931 300 B1 describes a leak-proof bottle for baby food having a bottom and top closure ring where the first and second seat surfaces are designed flat. This simplifies the production of the closure rings, prevents the collection of residual food and impurities, and makes it easier to clean the closure rings.

In addition, this patent describes a leak-proof bottle for baby food with bottom and top closure rings that have first and second middle parts with first and second seat surfaces in which first and second flow holes are arranged. A soft elastic sealing material consisting of plastic is injected-molded onto a sealing surface of the first middle part that sits on and seals the top edge of the bottle. With this bottle, the sealing material extends from the first seat surface through the through-holes over the side facing the interior of the bottle up to the sealing surface of the first middle part. Production is thereby simplified.

Furthermore, this patent describes a leak-proof bottle for baby food having a bottom closure ring and a top closure ring and a bayonet lock between the bottom closure ring and top closure ring that locks them to each other in a rotatable and releasable manner. The bayonet lock can be designed so that it does not contact baby food, and this counteracts impurities, reduces cleaning effort and makes use easier.

WO 2011/012310 A2 describes a locking system for a leak-proof bottle for baby food having a bottom closure ring and a top closure ring. The bottom closure ring has a bottom partition wall, and the top closure ring has a top partition wall. On the top side of the bottom partition wall, there is an annular lip seal concentric with the bottom closure ring that consists of a soft elastic material having at least one axially aligned sealing lip. At least one annular sealing geometry that is concentric with the top closure ring and engages with the lip seal is on the bottom side of the partition wall of the top closure ring. Both partition walls have flow holes that can be brought into overlapping and non-overlapping positions. In the exemplary embodiment, the lip seal is a double lip seal having two sealing lips extending vertically upward, and the sealing geometry has two annular, peripheral sealing grooves in which the sealing lips of the double lip seal engage. Alternately, the lip seal can be arranged on the bottom side of the top partition wall, and the sealing geometry can be arranged on the top side of the bottom partition wall.

Furthermore, this document describes a locking system for a leak-proof bottle for baby food having a bottom closure ring and a top closure ring. At least one bottom flow hole is arranged in a bottom partition wall of the bottom closure ring, and at least one top flow hole is arranged in the partition wall of the top closure ring. Furthermore, at least one sealing cushion in the shape of a pie wedge that consists of a soft elastic material is arranged on the bottom partition wall, and at least one top flow hole of the top partition wall has an edge-side sealing seat that is complementary with the pie wedge shape. By rotating the closure ring relative to the bottom closure ring, the top flow hole can be brought into an overlapping position relative to the bottom through-hole, and the sealing seat can be brought into a sealing position relative to the sealing cushion. Alternately, the pie-wedge shaped sealing cushion can be on the bottom side of the top partition wall, and the flow hole with the edge-side sealing seat that is complementary with the pie-wedge-shape can be in the bottom partition wall. These locking systems provide a particularly good seal.

In the known locking systems according to WO 2011/012310 A2, it requires a great deal of force to rotate the top closure ring relative to the bottom closure ring. In addition, leaks can arise due to the elevated internal pressure of the bottle. An elevated internal pressure can arise in the bottle in particular when food is shaken in or mixed in before drinking, for example when mixing powdered milk with water.

Given this background, the invention is based on creating a closure system for a leak-proof bottle for baby food that seals well and is easy to use.

### BRIEF SUMMARY OF THE INVENTION

The closure system for a leak-proof bottle for baby food has:
A bottom closure ring that has a substantially cylindrical bottom shell part with an inner thread that can be screwed onto an outer thread of a bottle, and a bottom partition wall above the inner thread that is connected at the edge to the bottom shell part and blocks the cross-section of the bottom shell part, the bottom partition wall having a first top side and a first bottom side with at least one bottom flow hole ending in the first top side and in the first bottom side,
A top closure ring that has a substantially cylindrical top shell part with an outer thread that is connectable to a threaded ring to fasten a teat to the top edge of the top shell part, and that has a top partition wall blocking the cross-section of the top shell part and is connected at the edge to the top shell part, the partition wall having a second top side and a second bottom side seated on and sealing the first top side with at least one top flow hole ending in the second bottom side and in the second top side,
Locking elements that lock the bottom closure ring and top closure ring with each other in a rotatable and releasable manner relative to each other,
Wherein a sealing lip that consists of a soft elastic material and is concentric with the bottom shell part projects upward from the first top side and expands radially outward at an increasing distance from the first top side and abuts a sealing surface under elastic pretension on the inside of a wall that projects downward from the second bottom side and is concentric with the top shell part, or vice versa, and the top flow hole can optionally be brought into overlapping and non-overlapping positions relative to the bottom flow hole by turning the top closure ring relative to the bottom closure ring.

With the closure system according to the invention, a particularly good seal is achieved between the bottom closure ring and top closure ring when the sealing lip consisting of soft elastic material contacts the inside of a sealing surface under elastic pretension. The contact between the sealing lip and the sealing surface can be restricted to an annular peripheral line or narrow strip. A good seal is achieved by means of the comparatively high surface pressure in the small contact surface, and only comparatively low friction forces act between the sealing lip and sealing surface. Consequently, the top closure ring can be rotated with only a slight amount of force relative to the bottom closure ring to open or close the closure system. In contrast, opening or closing the closure system according to WO 2011/012310 A2 requires a large amount of force due to the high friction in the large contact surface between the double lip seal and two sealing grooves. It is therefore easier for the user to use the closure system, nevertheless leaks are reliably prevented.

At the same time, the sealing lip allows a teat to be ventilated that is connectable to the top closure ring by means of a threaded ring. A vacuum in a teat can cause the sealing lip to lift off the sealing surface at least sectionally so that air can flow into the section between the partition walls through the gap or vent channel between the bottom closure ring and top closure ring and can enter through a top flow hole into the teat. A vent valve in the teat which is complicated to produce can be dispensed with. A vent channel or gap is preferably between the bottom closure ring and top closure ring and extends up to the sealing surface.

The designation “or vice versa” in the last feature of the claim indicates a version in which the sealing lip projects downward from the second bottom side of the top closure ring, and the wall with the sealing surface projects upward from the first top side of the bottom closure ring.

The closure system according to the invention for a leak-proof bottle for baby food has:
A bottom closure ring that has a substantially cylindrical bottom shell part with an inner thread that can be screwed onto an outer thread of a bottle, and a bottom partition wall above the inner thread that is connected at the edge to the bottom shell part and blocks the cross-section of the bottom shell part, the bottom partition wall having a first top side and a first bottom side with at least one bottom flow hole ending in the first top side and in the first bottom side,
A top closure ring that has a substantially cylindrical top shell part with an outer thread that is connectable to a threaded ring to fasten a teat to the top edge of the top shell part, and that has a top partition wall blocking the cross-section of the top shell part and is connected at the edge to the top shell part, the partition wall having a second top side and a second bottom side seated on and sealing the first top side with at least one top flow hole ending in the second bottom side and in the second top side,
Locking elements that lock the bottom closure ring and top closure ring with each other in a rotatable and releasable manner relative to each other,
where at least one sealing cushion consisting of a soft elastic material is arranged on and seals the bottom partition wall over a cutout in the bottom partition wall, and at least one top flow hole having an edge-side sealing seat complementary with the contour of the sealing cushion is arranged in the second bottom side of the top partition wall, and the top flow hole can optionally be brought into an overlapping position relative to the bottom through hole, and the sealing seat can be brought into a sealing position relative to the sealing cushion by turning the top closure ring relative to the bottom closure ring.

With the closure system according to the invention, the partition wall has a cutout below the sealing cushion. The cutout connects the first bottom side to the first top side of the bottom partition wall corresponding to the flow hole. A passage of liquid through the cutout is however prevented because the sealing cushion is arranged over and seals the cutout. The sealing cushion therefore blocks the cross-section of the cutout and is connected at the edge to the partition wall, providing a seal. When the sealing seat of the top flow hole is brought into a sealing position with reference to the sealing cushion by rotating the top closure ring relative to the bottom closure ring, the closure system prevents liquid from passing through. The seal is particularly good because elevated internal pressure in the container is applied against the bottom side of the sealing cushion, and this presses against the sealing seat on the edge of the top flow hole. Consequently, the seal of the sealing system is particularly good when it is necessary to ensure a seal under high pressure. Consequently, the sealing cushion only needs to lie against the sealing seat under a comparatively slight amount of elastic pretension when normal pressure acts on the bottom side of the sealing cushion. This makes it easier to adjust the closure system between open position and closed position. With the closure system according to WO 2011/012310 A2, the pie-wedge-shaped sealing cushion seated on the closed part of the partition wall contrastingly lies against the sealing seat under relatively high elastic pretension to reliably seal the bottle against overpressure in the bottle. This makes it more difficult to adjust the closure system between open and closed position.

According to one embodiment of the closure system with a sealing lip, the sealing lip is in the shape of a hollow cone. The greatest diameter of the hollow-cone-shaped sealing lip lies against the inside of the sealing surface, providing a seal. It is particularly advantageous in terms of production. Alternately, the sealing lip can be trumpet-shaped or have a cross-section with an L profile.

According to another embodiment, the inner diameter of the wall against and whose sealing surface the sealing lip lies, increases as the distance increases from the second bottom side of the top partition wall. This makes it easier to easily insert the sealing lip into its seat on the inside of the sealing surface and promotes and even sealing effect in the peripheral direction of the sealing lip.

According to another embodiment, the wall has the sealing surface at the sealing area wherein the wall has its smallest inner diameter, which is followed by a conical transitional region at which the inner diameter of the wall increases as the distance from the second bottom side increases. At a conical transitional region, the wall preferably has a cylindrical insertion region where it possesses its largest inner diameter. Possibly after being inserted in the cylindrical insertion region, the sealing lip can be shifted along the conical transitional region toward the sealing surface. As it shifts along the conical transitional region, the sealing lip is evenly subjected to elastic pretension.

According to another embodiment relating both to the closure system with a sealing lip and to the closure system with a sealing cushion, the locking elements are parts of a bayonet lock. The bayonet lock simultaneously allows the top closure ring to be locked with the bottom closure ring, and the top closure ring to be rotated relative to the bottom closure ring out of the open position into the closed position and vice versa.

According to another embodiment, the bayonet lock has at least one radially projecting hook on the top closure ring, and at least one complementary lengthwise groove in the bottom closure ring, and at least one complimentary ring groove proceeding from the bottom end of the lengthwise groove that is angled downward in an initial region neighboring the lengthwise groove and subsequently runs in a ring shape so that, by screwing the hook out of the lengthwise groove into the ring groove, the sealing lip can be displaced from a region of the wall's greatest inner diameter into a region of the wall's smallest inner diameter at which the sealing lip abuts the sealing surface under pretension. Alternatively, the bayonet lock has at least one radially projecting hook on the bottom closure ring, and at least one complementary lengthwise groove in the top closure ring, and at least one complimentary ring groove proceeding from the top end of the lengthwise groove that is angled upward in an initial region neighboring the lengthwise groove and subsequently runs in a ring shape so that, by screwing the hook into the ring groove, the sealing lip can be displaced from a region of the wall's greatest inner diameter into a region of the wall's smallest inner diameter where the it abuts the sealing surface under pretension.

The two above embodiments of the bayonet lock enable the sealing lip to be gradually shifted toward the sealing surface where the wall has its smallest diameter. The sealing lip is shifted into the sealing surface in a helical movement corresponding to the movement of the top closure ring dictated by the initial region of the ring groove. This yields a gradual, even, elastic pretension on the sealing lip to achieve a particularly good seal.

According to another embodiment, the bayonet lock has a plurality of hooks and lengthwise grooves symmetrically distributed around the bottom and top closure rings. This prevents the top closure ring from assuming an angled position in relation to the bottom closure ring when adjusting the bayonet lock and yields a more even pretension on the sealing lip.

According to a preferred embodiment, the bayonet lock has four hooks and lengthwise grooves symmetrically distributed around the bottom and top closure rings.

The hook preferably points radially inward, and the lengthwise groove opens radially outward. However, embodiments are also possible in which the hook points radially outward, and the lengthwise groove opens radially inward.

According to another embodiment, the top closure ring has a downward projecting tongue in addition to a hook on the top shell part, and the bottom closure ring has a partially peripheral groove on the bottom shell part that opens upward and starts next to a lengthwise groove so that the tongue engages from above in the partially peripheral groove upon inserting the hook next to it into the lengthwise groove and, by rotating the top closure ring relative to the bottom closure ring in the groove, can be shifted into an open position in which the flow holes of the top closure ring and bottom ring overlap each other and, by rotating further in the peripheral groove, can be shifted into a closed position at the end of the groove in which the top flow hole and the bottom flow hole do not overlap each other. The tongue is a position marker that indicates the respective setting of the closure system to the user. At the same time, the tongue is an ergonomic contact point that makes it easier for the user to grip and rotate the top closure ring relative to the bottom closure ring. This is particularly advantageous since the closure system is smudged, or the user's hands are wet with liquid.

According to another embodiment, the bottom closure ring has a nib projecting radially outward from the bottom shell part. The nib improves the grip of the bottom closure ring. This is particularly advantageous when the closure system is smudged, or the user's hands are wet with liquid.

According to another embodiment of the closure system with a sealing cushion, the sealing cushion has three primary sides of which two linear sides point toward the center of the bottom partition wall, and the third side runs curved in an arc around the center of the bottom partition wall, and/or the bottom and top flow holes have a corresponding contour. The contour of the sealing cushion or flow holes is particularly advantageous for liquid to flow out of the opened closure system.

According to another embodiment, there is a narrow curvature radius between the linear slides, and/or between the linear sides and the curved side of the sealing cushion, and/or the flow holes. This is also advantageous for the outflow of milk and the seal of the flow holes.

According to another embodiment, the sealing cushion has a peripheral edge region where the wall is thicker, and a central region above the cutout where the wall is thinner. The edge region provides a good seal in closed position. In addition, the transition between the edge region and central region indicates to the user that he has correctly adjusted the sealing cushion on the flow hole.

According to another embodiment, the sealing lip consists of a thermoplastic elastomer, and/or the sealing cushion consists of a thermoplastic elastomer. The bottom and top closure rings preferably consists of polypropylene. Alternately, the sealing lip and/or the sealing cushion consist of silicone rubber.

### BRIEF DESCRIPTION OF THE SEVERAL VIEWS OF THE DRAWINGS

The invention will be explained below with reference to an exemplary embodiment that is portrayed in the accompanying drawings. In the drawings:

FIG. 1 A vertical section of a closure system screwed onto a bottle for baby food having a screwed-on nipple;

FIG. 2a-i The bottom closure ring of the same closure system in a front view (FIG. 2a), in a view from the right side (FIG. 2b), in a view from the left side (FIG. 2c), in a top view (FIG. 2d), in a bottom view (FIG. 2e), in a section following line (A-A) from FIG. 2e (FIG. 2f), a section following line B-B from FIG. 2f (FIG. 2g), in a perspective view angled from above and from the side (FIG. 2h) and in a perspective view angled from below and from the side (FIG. 2i);

FIG. 3a-g The top closure ring of the same closure system in a front view (FIG. 3a), in a view from the right side (FIG. 3b), in a view from the left side (FIG. 3c), in a top view (FIG. 3d), in a bottom view (FIG. 3e), in a section following line A-A from FIG. 3d (FIG. 3f), in a section following line B-B from FIG. 3d (FIG. 3g);

FIG. 4a-d The closure system composed of the bottom and top closure ring in an assembled position in a front view (FIG. 4a), in a vertical section (FIG. 4b), in a top view (FIG. 4c) and in a section following line D-D from FIG. 4a (FIG. 4d);

FIG. 5a-g The same closure system in opened position in a front view (FIG. 5a), in a bottom view (FIG. 5b), in a section following line A-A from FIG. 5b (FIG. 5c), in a section following line B-B from FIG. 5b (FIG. 5d), in a view from the right side (FIG. 5e), in a perspective view angled from above and from the side (FIG. 5f) and in a perspective view angle from below and from the side (FIG. 5g);

FIG. 6a-d The same closure system in closed position in a front view (FIG. 6a), in a top view (FIG. 6b), in a section following line B-B from FIG. 6b (FIG. 6c) and in a section following line D-D from FIG. 6b (FIG. 6d).

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

In the present application, the designations “top” and “bottom” relate to the alignment of the closure system when it is screwed onto a bottle with a teat, the bottle is vertically aligned and its bottom is resting on a base, and the nipple is located above the bottle.

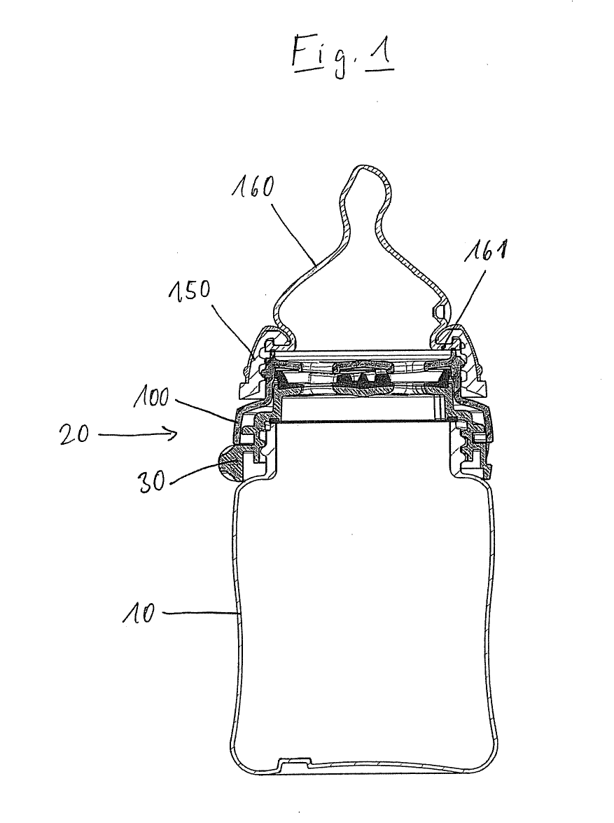

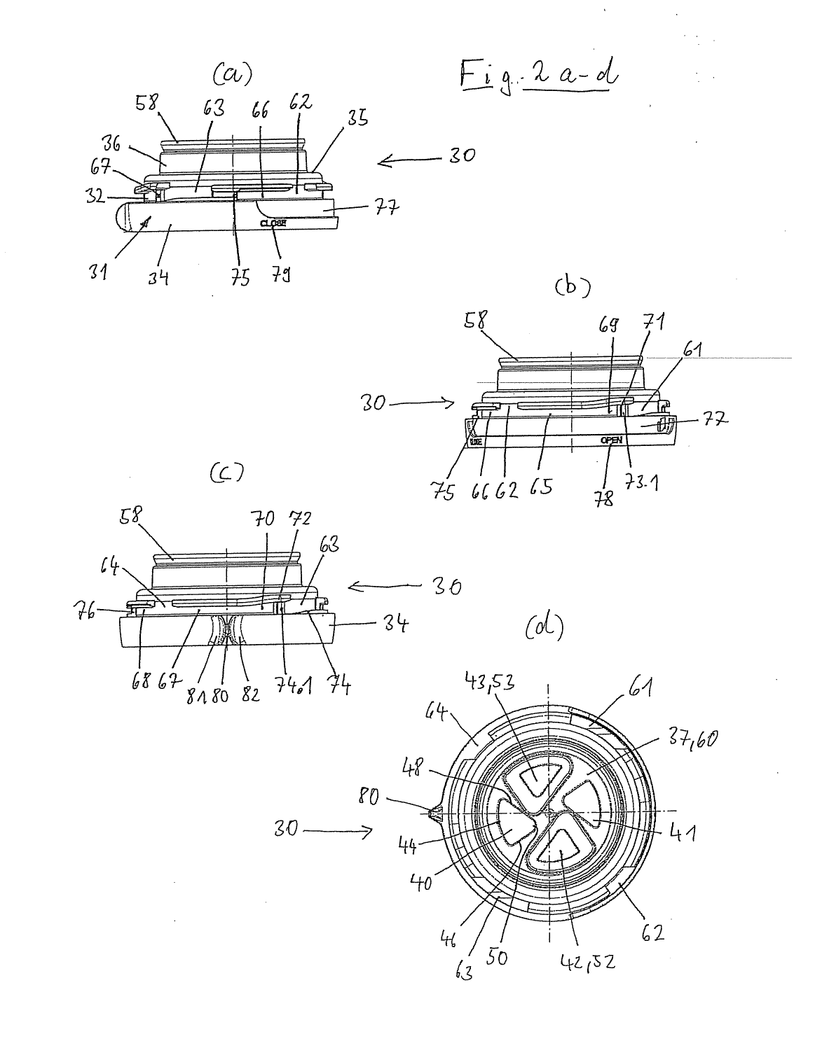

According to FIG. 1, a closure system 20 having a bottom closure ring 30 and a top closure ring 100 is screwed onto a bottle 10 for baby food. A nipple 160 is screwed onto the closure system 20 by means of a threaded ring 150.

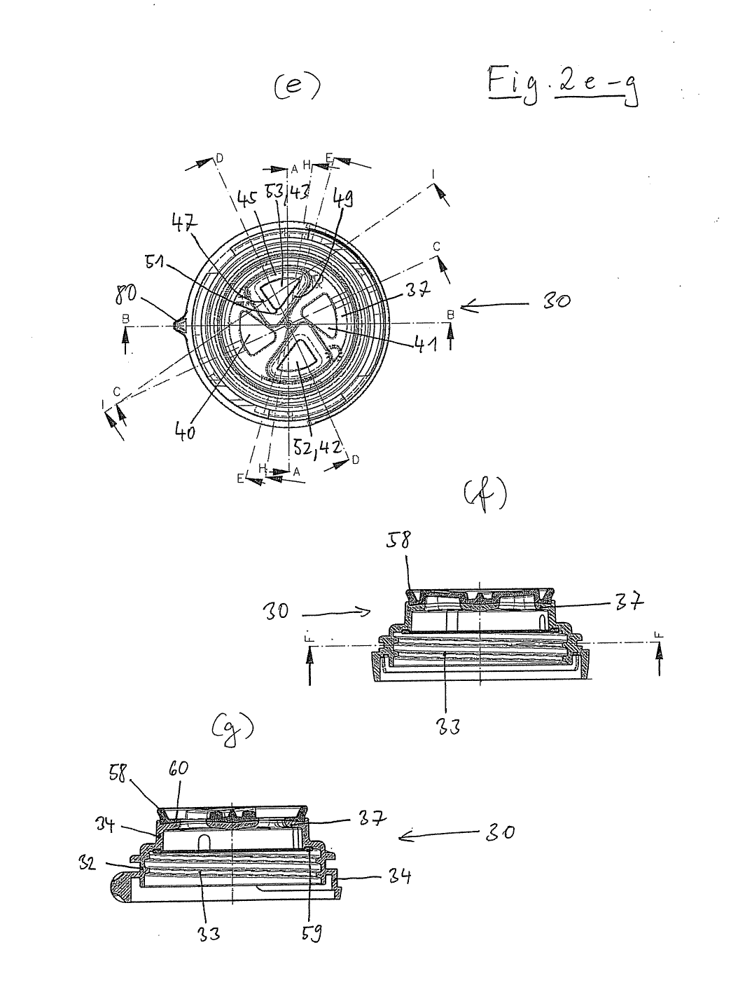

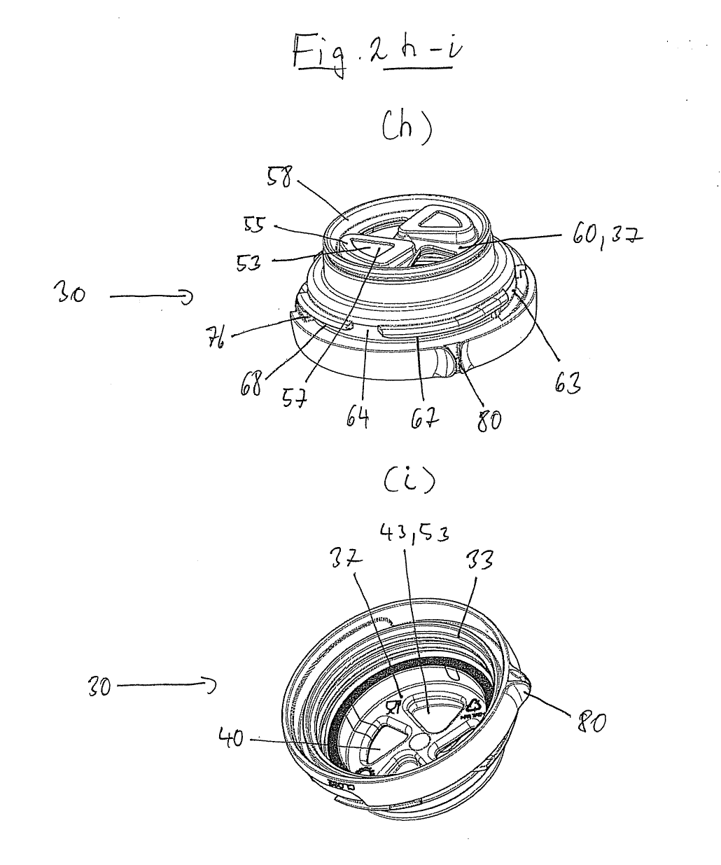

According to FIG. 2, the lower closure ring 30 has a substantially cylindrical lower casing portion 31 having a plurality of sections. The first bottom shell section 32 with the substantially cylindrical shape has an inner thread 33 on the inner circumference. A second, bottom shell section 34 extends radially outward and downward from the bottom shell section 32.

In addition, the bottom shell part 31 has a third, bottom shell section 35 that is substantially disc-shaped and projects radially inward from the top edge of the first, bottom shell section 32. A substantially cylindrical, fourth bottom shell section 36 projects radially upward from the inside of the third, bottom shell section 35.

A bottom partition wall 37 is connected to the top edge of the fourth, bottom shell section 36 and substantially blocks the cross-section of the bottom closure ring 30. This disc-shaped partition wall 37 has a substantially flat first top side 38 and a substantially flat first bottom side 39. In addition, it has diametrically opposing flow holes 40, 41 that extend from the first top side 38 to the first bottom side 39. Furthermore, it has diametrically opposing cutouts 42, 43 that also extend from the first top side 38 to the first bottom side 39.

The flow holes 40, 41 and cutouts 42, 43 each have a curved side 44, 45 that runs concentric to the perimeter of the disc-shaped partition wall 37. Furthermore, they have a short and a long a linear side 44, 47 and 48, 49, where the linear side extends toward the center of the partition wall 37. Small radii 50, 51 are between the curved and the linear sides, as well as between the linear sides.

The long sides 48 of the flow holes 40, 41, 42 are arranged parallel with each other, and the short sides of the flow holes 40, 41 are arranged parallel with each other. The long and short sides 49, 47 of the cutouts 42, 43 are correspondingly aligned.

Consequently, the flow holes 40, 41 and the cutouts 42, 43 widen at an increasing distance from the center of the partition wall 37.

The focal points of the flow holes 40, 41 are diametrically opposed, as are the focal points of the cutouts 42, 43.

The cutouts 42, 43 are covered by sealing cushions 52, 53 that are connected at the edge to the first top side 38, providing a seal. The sealing cushions 52, 53 have a contour that corresponds to the contour of the cutouts 42, 43. The sealing cushions 52, 53 each have an edge region 54, 55 where the wall is thicker, and a central region 56, 57 where the wall is thinner.

An individual hollow conical sealing lip projects from the edge of the first top side 38 of the partition wall 37. The sealing lip 58 is concentric with the partition wall 37 in the bottom shell part 31. The outer diameter of the sealing lip 58 increases at an increasing distance from the partition wall 37.

Furthermore, the bottom closure ring 30 has a disc-shaped sealing element 59 on the bottom side of the third, bottom shell section 35.

A layer 60 that consists of a soft elastic sealing material and does not cover the flow holes 40, 41 is arranged on the first top side 38. On the edge, the peripheral sealing lip 58 projects from this layer, and the sealing cushions 52, 53 project above the cutouts 42, 43. The sealing lip 58 and the sealing cushions 52, 53 are formed as a single part with the layer 60. Furthermore, the layer 60 of soft elastic sealing material is connected to the disc-shaped sealing element 59 via connections made of the same material. These connections extend through cutouts in the curved sides 44 of the flow holes 40, 41 and channels in the bottom side of the partition wall 37 and the inside of the fourth bottom shell section 36.

Furthermore, on the outer perimeter of the first bottom shell section 32, the bottom closure ring 30 has four opposing lengthwise grooves 61, 62, 63, 64 that are each connected to an ring groove 65, 66, 67, 68 that are bordered at the bottom by the second bottom shell section 34. Neighboring the lengthwise grooves 61, 63 is a starting region 69, 70 at a downward angle in the ring grooves 65, 67. This is formed by a rib 71,72 boarding the top of the ring groove 65, 67. In addition, the bottom of the lengthwise groove 61, 63 is bordered by a ramp 73,74 that is angled corresponding to the rib 71,72.

On the base of the ring grooves 65, 67, small bumps 73.1, 74.1 that project radially outward are arranged next to the lengthwise grooves 61,63. These each have a slightly angled ramp 73.11, 74.11 and a strongly angled ramp 73.12, 74.12. The slightly angled ramps 73.12, 74.12 face the neighboring lengthwise grooves 61, 63. The strongly angled ramps 73.12, 74.12 face away from the neighboring lengthwise grooves 61, 63.

The two starting regions 69, 70 angle downward. Adjacent thereto, the ring grooves 65, 67 run in a ring on the first bottom shell section 32 like ring grooves 66, 68.

The ring grooves 66, 68 are delimited at the ends by stops 75, 76 that also separate them from the neighboring lengthwise grooves 61, 62, 63, 64.

Furthermore, the bottom closure ring 30 on the perimeter of the second bottom shell section 34 has a partially peripheral groove 77 that opens upward. This begins next to the lengthwise groove 61 and extends approximately to the middle of the ring grooves 66. The ends of the groove 77 that opens upward are rounded. At a distance of approximately 30 to 40 angular degrees from the end neighboring lengthwise groove 61, the second bottom shell section 34 is provided with a marking 78 (“Open”) next to the open groove 77 for an open position, and at the other end with another marking 79 (“Close”) for a closed position.

Diametrically opposed to the open groove 77, a nib 80 projects radially outward from the first, bottom shell part. The nib 80 has two concave side surfaces 81, 82 rounded on the outside.

The bottom closure ring 30 is made of a hard elastic plastic such as polypropylene (PP). Production preferably occurs by means of injection molding. The sealing lip 58, the sealing cushions 52, 53, the sealing element 59 and the soft elastic layer 60 are formed by injection molding soft elastic sealing material. Since the projecting sealing elements are connected to each other, the sealing material can be injection molded in a single injection molding step. The sealing material is preferably a thermoplastic elastomer (TPE) or an injectable silicone rubber.

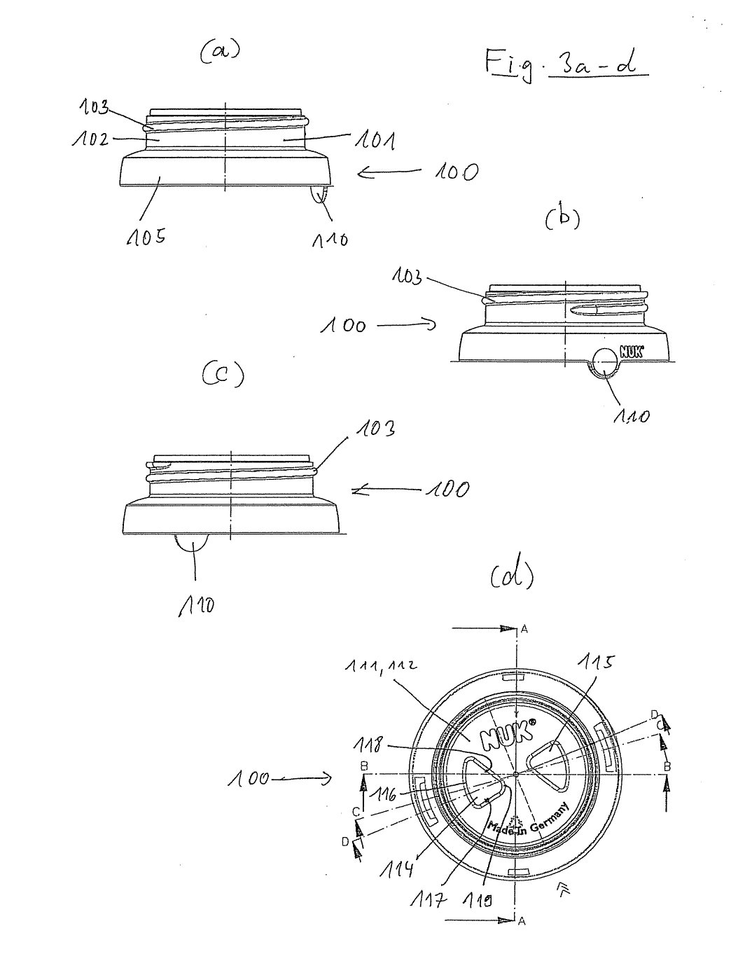

According to FIG. 3, the top closure ring 100 has a top shell part 101 with a plurality of sections. A substantially cylindrical, first top shell section 102 has an outer thread 103 on the outer perimeter. The first top shell section 102 is connected at the bottom edge to a second top shell section 104 that projects radially outward. In the example, the second top shell section 14 is in the shape of a hollow cone. It can contrastingly be disc-shaped. The second, top shell section 104 is connected at the outer perimeter to a third top shell section 105 that projects axially downward.

The third top shell section 105 is substantially cylindrical. It has an inner perimeter and four hooks 106, 107, 108, 109 that project radially inward, where the wider hooks 106, 108 and the narrow hooks 107 and 109 are diametrically opposed to each other. The hook 107 is offset from hook 106, and the hook 109 is offset from the hook 108 by approximately 70 angular degrees in a peripheral direction.

In addition, the third top shell section 105 has an approximately semicircular tongue 110 that projects axially downward. Next to the tongue 110, the hook 106 projects radially inward from the third top shell section 105.

In addition, the top closure ring 100 has a disk-shaped top partition wall 111 that is connected to the first top shell section 102 slightly below its top edge and blocks the cross-section of the top shell part 101. The top partition wall 111 has a substantially flat second top side 112 and a substantially flat second bottom side 113.

In addition, it has diametrically opposed top through holes 114, 115 that each end in the second top side 112 and the second to bottom side 113. The top through holes 114, 115 diametrically oppose each other. They have a curved side 116 that runs concentric to the perimeter of the top partition wall 111. In addition, they have a short, straight side 117 and a long straight side 118 that extend from the ends of the curved side 116 proceeding from the center of the partition wall 111 where they meet. There are small curvature radii 119 between the curved sides 116 and the straight sides 117, 118 and between the straight sides 117, 118. The long sides 118 of the through-holes 114, 115 are parallel to each other as are the narrow sides 117. The focal points of the through-holes are arranged approximately in a diametrically opposed manner. The shape of the flow-holes of the top closure ring 100 is complementary with the shape of the flow-holes 40, 41 of the bottom closure ring 30.

At the edge of the through-holes 114, 115, sealing beads 120, 121 project downward from the second bottom side 112. The sealing beads 120, 121 each run around the through-holes 114, 115.

The inner parameter of the first top shell section 102 has a hollow cylindrical sealing area 122 directly below the top partition wall 111 where the inner diameter of the top shell part 101 is smallest. The inside of the sealing area 122 forms a sealing surface 123 for the lip seal. A conical transitional region 124 abuts the bottom of the sealing area 122 at which the inner diameter of the top shell section 102 gradually expands downward. Abutting the conical transitional section is a cylindrical insertion area 125 at which the diameter of the first top shell section 102 is widest.

The top closure ring 100 is always made of a hard elastic plastic such as PP. It is preferably produced by means of injection molding.

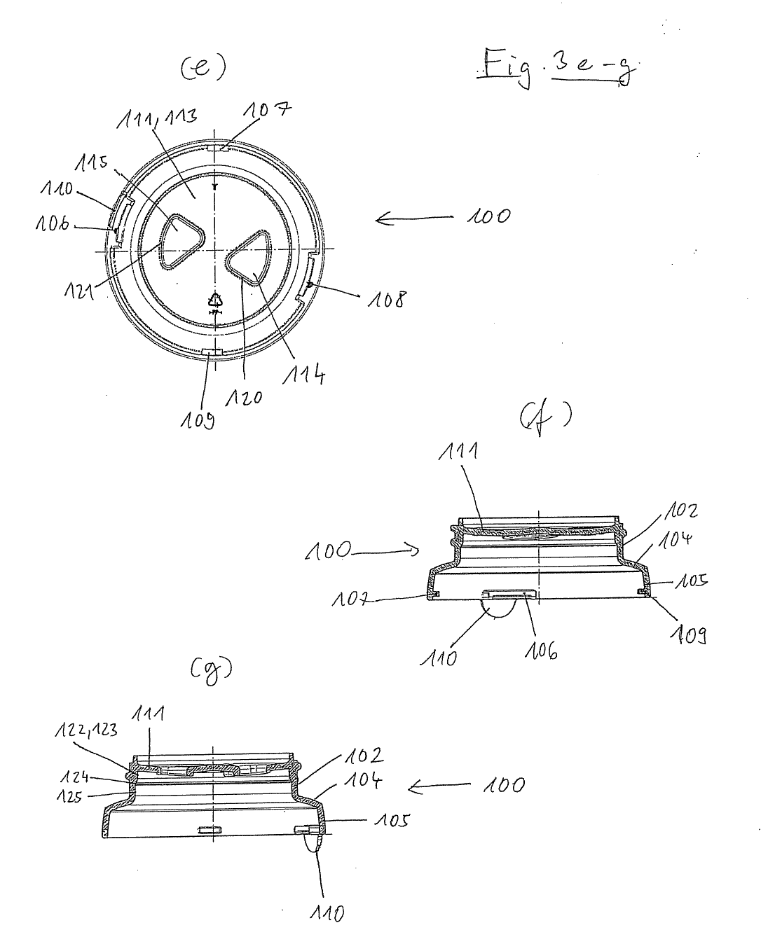

The hooks 106, 107, 108, 109 of the top closure ring 100 can be inserted into the lengthwise grooves 61, 62, 63, 64 of the bottom closure ring 30 until the hooks 106, 108 contact the ramps 73, 74 on the top side of the second bottom shell section 34. The sealing lip 58 thereby engages in the insertion area 125 on the inside of the first top shell section 102. Furthermore, the tongue 110 engages in the open groove 77 from above. The closure parts 30, 100 in FIG. 4 are shown in this assembled position in which a gap is visible between the third top shell section 105 and second bottom shell section 34.

In this assembled position, the top closure part 100 is not yet undetachably connected to the bottom closure part 30.

For an undetachable connection, the top closure part 100 is rotated out of the assembled position relative to the bottom sealing part 30. The hooks 106, 108 are moved thereby along the downward angled starting regions 69, 70 of the ring grooves 65, 67, and the sealing lip 58 is shifted along the transitional region 124 toward the sealing surface 123. Each point of the sealing lip 58 is thereby shifted along a helical line. Due to the reduction in the diameter, the sealing lip 58 is pretensioned radially. When the hooks 106, 108 enter the annular part of the ring grooves 65, 67, the sealing lip 58 is radially pretensioned against the sealing surface 123.

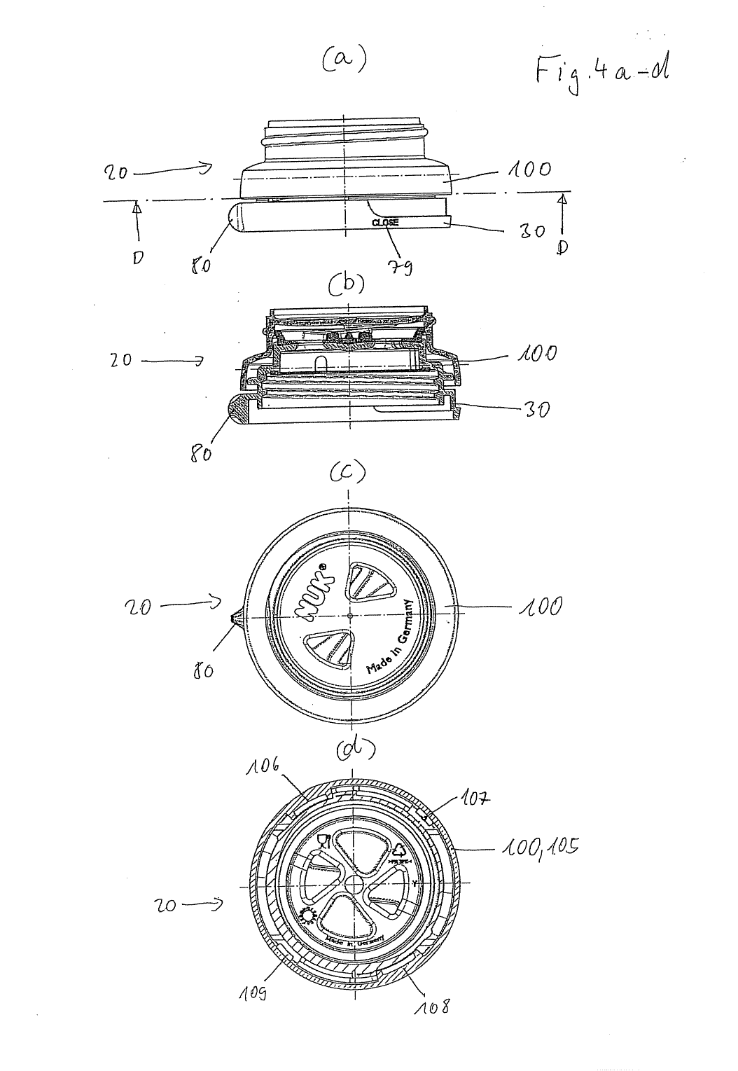

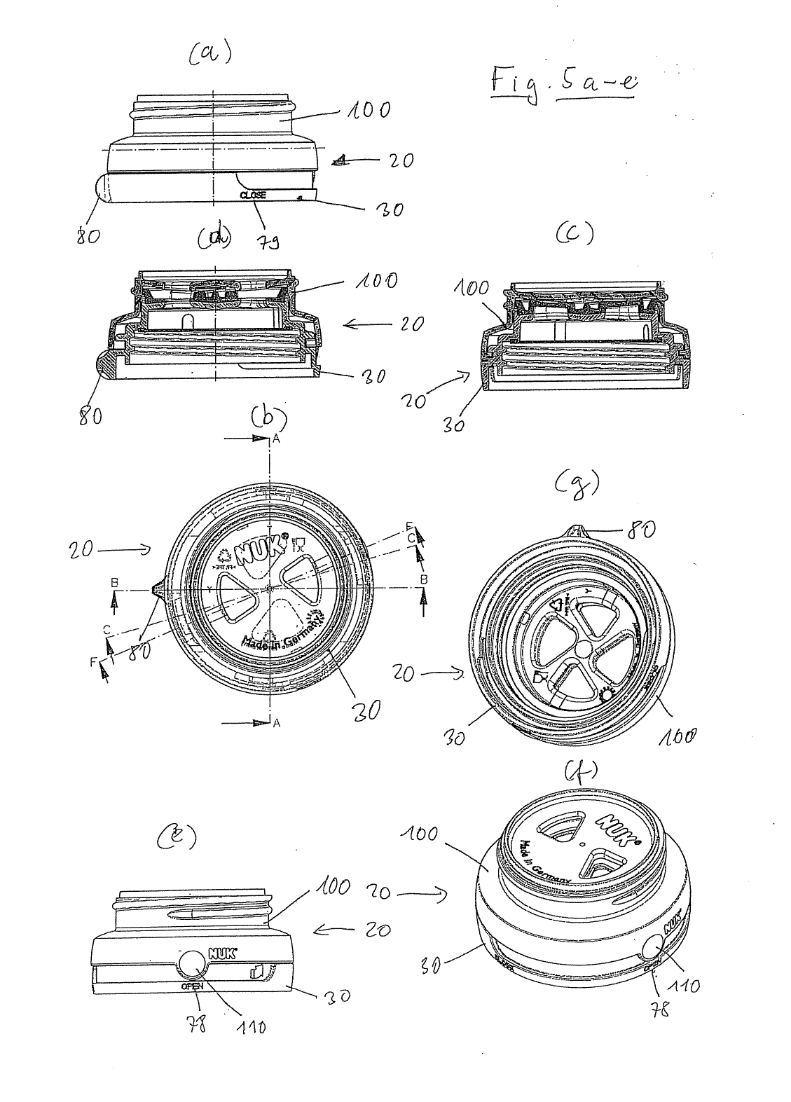

While being screwed into the ring grooves 65, 67, the hooks 106, 108 first slide across the slightly angled ramps 73.11, 74.11 toward the bumps 73.1, 73.2. The third top shell section 105 is thereby elastically expanded radially in a diametrical direction by the two hooks 106, 108. When the hooks 106, 108 go past the strongly angled ramps 73.12, 84.12 of the bumps 73.1, 74.1, the third top shell section 105 retracts slightly. This creates a safety lock. In this rotational position, the two flow openings 114, 115 of the top closure ring 100 are arranged to precisely overlap above the flow openings 40, 41 of the bottom closure ring 30. In addition, the tongue 110 points toward the markings 78 that indicate the open state. This situation is shown in FIG. 5. In this position, liquid can pass through the bottom and top partition walls 37, 111.

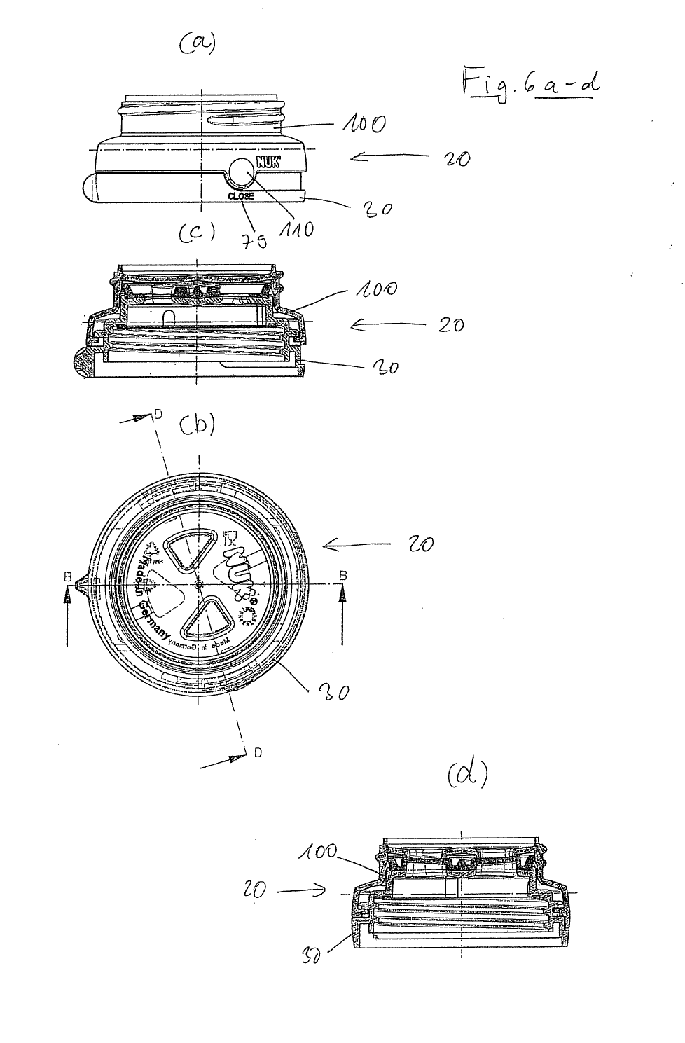

When the top closure ring 100 is rotated further in the same direction, the hooks 107, 109 finally reach the end stops 73, 76 in the ring grooves 66, 68, and the time 110 reaches the end of the top open groove 77. In this rotational position, the reinforced edge areas 54, 55 of the sealing cushions 52, 53 precisely press against the beads 120, 121 on the bottom side of the top flow openings 114, 115. The top flow openings 114, 115 are thereby sealed. In this situation which is shown in FIG. 6, the tongue 110 points toward the marking 79 on the bottom closure ring 30 that indicates the closed position.

To reach the open position, the top closure ring 100 is rotated in the opposite direction until the tongue 100 points toward the corresponding marking 78.

To disassemble, the top closure ring 100 is rotated further in the same rotational direction, wherein the hooks 106, 108 first need to be moved with slightly elevated force over the steep ramps 73.12, 74.12 of the bumps 73.1, 74 which releases the safety lock. When the hooks 106, 108 are guided over the ramps 73, 74 to the lengthwise sides 61, 63, the sealing lip 58 is moved out of the sealing area 122. When the hooks 106, 107, 108, 109 completely engage in the lengthwise grooves 61, 62, 63, 64, the top closure ring 100 can be withdrawn from the bottom closure ring 30.

According to FIG. 1, the closure system 30, 100 with the inner thread 33 in the bottom closure body 30 is screwed onto a bottle outer thread 11 on a neck 12 of the bottle 10. The sealing element 59 presses against the top edge of the neck 12 that surrounds the bottle opening. This causes the bottom closure ring 30 to be tightly seated on the bottle 10.

In addition, the teat 166 is clamped with a nipple flange 161 between the top edge of the top closure ring 100 and the threaded ring 130 that is screwed onto the outer thread 103 of the top closure ring 100. The nipple 160 is thereby tightly connected to the top closure ring 100.

By adjusting the closure system 30, 100 in the open position, liquid baby food can be ingested from the bottle 10. By adjusting the closure system 30, 100 in the closed position, removal is prevented. In all positions, the lip seal 58, 123 ensures that liquid can not exit laterally between the top and bottom closure ring 30, 100. At the same time, the sealing lip 58 can ensure that the teat 160 is ventilated in that it lifts at least partially from the sealing surface 123 starting at a specific vacuum in the teat 160 so that a gap can arise between the sealing lip 58 and the sealing surface 123. This preferably occurs independently in the area that is not touching liquid since this is where the highest vacuum exists. Therefore no liquid leaks during ventilation by means of the sealing lip 58.

This completes the description of the preferred and alternate embodiments of the invention. Those skilled in the art may recognize other equivalents to the specific embodiment described herein which equivalents are intended to be encompassed by the claims attached hereto.

1. A closure system for a leak-proof bottle for baby food comprising:
A bottom closure ring (30) that has a substantially cylindrical bottom shell part (31) with an inner thread (33) that can be screwed onto an outer thread of a bottle, and a bottom partition wall (37) above the inner thread (33) on the edge that is connected to the bottom shell part (31) and blocks the cross-section of the bottom shell part (31), the bottom partition wall having a first top side (38) and a first bottom side (39) with at least one bottom flow hole (40, 41) ending in the first top side and in the first bottom side,
A top closure ring (100) that has a substantially cylindrical top shell part (101) with an outer thread (103) that is connectable to a threaded ring to fasten a teat to the top edge of the top shell part (101), and that has a top partition wall (111) blocking the cross-section of the top shell part (101) and is connected at the edge to the top shell part (101), the partition wall having a second top side (112) and a second bottom side (113) seated on and sealing the first top side with at least one top flow hole, (114, 115) ending in the second bottom side and in the second top side,
Locking elements (61 to 68, 106 to 108) that lock the bottom closure ring (30) and top closure ring (100) with each other in a rotatable and releasable manner relative to each other, and
Wherein a sealing lip (58) that consists of a soft elastic material and is concentric with the bottom shell part (31) projects upward from the first top side (38) and expands radially outward at an increasing distance from the first top side (38) and abuts a sealing surface (123) under elastic pretension on the inside of a wall (102) that projects downward from the second bottom side (113) and is concentric with the top shell part (101), or vice versa, and the top flow hole (114, 115) can optionally be brought into overlapping and non-overlapping positions relative to the bottom flow hole (40, 41) by turning the top closure ring (100) relative to the bottom closure ring (30).

2. The closure system for a leak-proof bottle for baby food comprising:
A bottom closure ring (30) that has a substantially cylindrical bottom shell part (31) with an inner thread (33) that can be screwed onto an outer thread of a bottle, and a bottom partition wall (37) above the inner thread (33) on the edge that is connected to the bottom shell part (31) and blocks the cross-section of the bottom shell part (31), the bottom partition wall having a first top side (38) and a first bottom side (39) with at least one bottom flow hole (40, 41) ending in the first top side and in the first bottom side,
A top closure ring (100) that has a substantially cylindrical top shell part (101) with an outer thread 103) that is connectable to a threaded ring to fasten a teat to the top edge of the top shell part (101), and that has a top partition wall (111) blocking the cross-section of the top shell part (101) and is connected at the edge to the top shell part (101), the partition wall having a second top side (112) and a second bottom side (113) seated on and sealing the first top side with at least one top flow hole, (114, 115) ending in the second bottom side and in the second top side,
Locking elements (61 to 68, 106 to 109) that lock the bottom closure ring (30) and top closure ring (100) with each other in a rotatable and releasable manner relative to each other, and
where at least one sealing cushion (52, 53) consisting of a soft elastic material is arranged on and seals the bottom partition wall (37) over a cutout (42, 43) in the bottom partition wall (37), and at least one top flow hole (114, 115) having an edge-side sealing seat (120, 121) complementary with the contour of the sealing cushion is arranged in the second bottom side (113) of the top partition wall (111), and the top flow hole (114, 115) can optionally be brought into an overlapping position relative to the bottom through hole (40, 41), and the sealing seat (120, 121) can be brought into a sealing position relative to the sealing cushion (52, 53) by turning the top closure ring (30) relative to the bottom closure ring.

3. (canceled)

4. The closure system according to claim 1, wherein the sealing lip (58) is in the shape of a hollow cone.

5. The closure system according to claim 1, wherein the inner diameter of the wall increases (102) at an increasing distance from the second bottom side (113).

6. The closure system according to claim 5, wherein the wall (102) has the sealing surface (123) at a sealing area (122) wherein the wall has its smallest inner diameter, which is followed by a conical transitional region (124) at which the inner diameter of the wall (102) increases as the distance from the second bottom side (113) increases.

7. The closure system according to claim 6, wherein at a conical transitional region, the wall (102) preferably has a cylindrical insertion region (125) where it possesses its largest inner diameter.

8. The closure system according to claim 1, wherein the locking elements (61 to 68, 106 to 109) are parts of a bayonet lock.

9. The closure system according to claim 1,
Wherein the bayonet lock has at least one radially projecting hook (106 to 109) on the top closure ring (100), and at least one complementary lengthwise groove (61 to 64) in the bottom closure ring (30), and at least one complimentary ring groove (65 to 68) proceeding from the bottom end of the lengthwise groove (61 to 64) that is angled downward in an initial region (69, 70) neighboring the lengthwise groove (61 to 64) and subsequently runs in a ring shape so that, by screwing the hook (106, 108) out of the lengthwise groove (61, 62) into the ring groove (65, 67), the sealing lip (58) can be displaced from a region of the greatest inner diameter of the wall (102) into a region of the wall's smallest inner diameter at which the sealing lip (58) abuts the sealing surface (123) under pretension.

10. The enclosure system according to claim 8, wherein the bayonet lock has a plurality of hooks (106 to 109) and lengthwise grooves (61 to 64) symmetrically distributed around the bottom and top closure rings.

11. The enclosure system according to claim 10, wherein the bayonet lock has four symmetrical hooks (106 to 109) and lengthwise grooves (61 to 64) distributed around the bottom and top closure rings.

12. The closure system according to claim 8, wherein the top closure ring (100) has a downward projecting tongue (110) in addition to a hook (106) on the top shell part, and the bottom closure ring (30) has a partially peripheral groove (77) on the bottom shell part that opens upward and starts next to a lengthwise groove (61) so that the tongue (110) engages from above in the groove facing upward (77) upon inserting the hook (106) next to it into the lengthwise groove (61) and, by rotating the top closure ring relative to the bottom closure ring (100) in the groove (77), can be shifted into an open position in which the flow holes (114, 115, 40, 41) of the top closure ring (30) and bottom ring (30) overlap each other and, by rotating further in the groove (77), can be shifted into a closed position at the end of the groove in which the top flow hole and the bottom flow hole (114, 115, 40, 41) do not overlap each other.

13. The closure system according to claim 8, wherein the bottom closure ring (30) has a nib (80) projecting radially outward from the bottom shell part.

14. The closure system according to claim 2, wherein the sealing cushion (52, 53) has three primary sides of which two linear sides point toward the center of the bottom partition wall (37), and the third side runs curved in an arc around the center of the bottom partition wall (37), and/or the bottom and top flow holes (40, 41, 114, 115) have a corresponding contour.

15. The closure system according to claim 14, wherein there is a narrow curvature radius between the linear slides, and/or between the linear sides and the curved side of the sealing cushion (52, 53), and/or the flow holes (40, 41, 114, 115).

16. The closure system according to claim 2, wherein the sealing cushion (52, 53) has a peripheral edge region where the wall is thicker, and a central region above the cutout (42, 43) where the wall is thinner.

17. The closure system according to claim 1 wherein the bayonet lock has at least one radially projecting hook (106 to 109) on the bottom closure ring (30), and at least one complementary lengthwise groove (61 to 64) in the top closure ring (100), and at least one complimentary ring groove (65 to 68) proceeding from the top end of the lengthwise groove (61 to 64) that is angled upward in an initial region (69, 70) neighboring the lengthwise groove (61 to 64) and subsequently runs in a ring shape so that, by screwing the hook (106, 108) into the ring groove (65, 67), the sealing lip (58) can be displaced from a region of the greatest inner diameter of the wall (102) into a region of the wall's smallest inner diameter at which it abuts the sealing surface (123) under pretension.
